(19) United States
(12) Patent Application Publication
(10) Pub. No.: US 2004/0098605 A1
(43) Pub. Date: May 20, 2004

(54) Prospective execution of function based on partial correlation of digital signature

(75) Inventor: David J. Kasper II, Aliso Viejo, CA (US)

Correspondence Address: Fogg and Associates, LLC, P.O. Box 581339, Minneapolis, MN, 55458-1339, US

(73) Assignee: ADC DSL Systems, Inc.

(21) Appl. No.: 10/295,064

(22) Filed: Nov. 15, 2002

(51) Int. Cl. G06F 11/30

(52) U.S. Cl. 713/200

(57) ABSTRACT

A method for initiating an action based on a received signature in an input signal is provided. The method includes receiving elements of the input signal, determining when elements of the input signal match corresponding elements in the signature, and initiating a selected action when a selected subset of the elements of the signature match consecutive elements of the input signal.

### CROSS REFERENCE TO RELATED APPLICATION

This application is related to co-pending application Ser. No. 10/195,236 entitled “DIGITAL CORRELATION” (the '236 application). The '236 application is incorporated herein by reference.

### TECHNICAL FIELD

The present invention relates generally to the field of electronic circuits and, in particular, to prospective execution of a function based on partial correlation of a digital signature.

### BACKGROUND

Electronic circuits perform many functions in a variety of applications and systems. Such systems and applications range from computers and communications systems to automobiles and control systems for other industrial machinery.

Electronic circuits typically receive one or more inputs and produce one or more outputs. The type of output is determined, at least in part, by the input signal and the function of the electronic circuit. For example, electronic circuits provide outputs that drive visual displays, control mechanical apparatus, drive other electronic circuits, store or manipulate data or provide other appropriate output functions or signals.

In some electronic systems, input signals are analyzed to determine whether the input signal matches one or more known patterns. When the input signal matches one of the patterns, the electronic circuit takes selected action. For example, in a wireless communication system, when an input stream matches a known synchronization pattern, the system begins processing data received over a wireless link. In computer systems, an input stream is often monitored for one or more known input patterns. When a known pattern is received, a selected screen is displayed on a monitor.

There are many techniques for matching or correlating a sampled input to a reference signature. Some techniques are based on vector subtraction or exclusive NOR. For example, consider a Boolean (base-2) reference signature S and input signal X, both of length N. Signals S and X are represented as follows:

S=[K₀, K₁, K₂, . . . K_{N-1}]and

X=[I(t), I(t-1), I(t-2), . . . I(t−(N−1))].

S is considered correlated (matches) X when the two vectors are equal. A simple test for correlation is to subtract one vector from the other and declare correlation if the result equals zero. Another common hardware implementation is to perform the AND function of the exclusive NOR for corresponding vector elements. Similar approaches also apply to signals of any base-M type.

Unfortunately, these common techniques require a history of data to be maintained by the electronic circuit. This history is typically maintained via an array in software or a shift register in hardware. These techniques are adequate for systems with small signatures, S, and small bases, e.g., binary signals. Resource efficiency becomes an issue when large vectors are required to determine correlation. This is due, in part, to large quantities of memory, e.g., RAM, used to maintain the input signal history. Further, there is a linear relationship between processor bandwidth and vector size, e.g., N subtractions are performed every time the input is sampled. Thus, processor bandwidth requirements can become large with increasing vector size.

Further, in some circumstances, it takes a significant amount of time to correlate a signal in an input stream to a signature. Unfortunately, this can hold up the output, e.g., the execution of the function or action, associated with the signature. This is particularly problematic when the output itself is a time consuming function.

Therefore, there is a need in the art for more efficient and timely techniques for correlating a sampled input stream to a reference signature to reduce delays in subsequent processes.

### SUMMARY

Embodiments of the present invention allow prompt action to be taken when correlating to a digital signature by initiating the action before the received signal is fully matched with the signature. In one embodiment, the process takes action based on a partial match between the signature and the input stream, e.g., when a specified percentage of the signature has been successfully matched. Advantageously, by taking action based on partial correlation, embodiments of the present invention reduce the effective time needed to complete the action by correlating the remaining portion of the signature while initiating the action. If the remaining portion of the signature does not match, then the action is canceled before completion of the action.

In one embodiment, a method for initiating an action based on a received signature in an input signal is provided. The method includes receiving elements of the input signal, determining when elements of the input signal match corresponding elements in the signature, and initiating a selected action when a selected subset of the elements of the signature is matched in consecutive elements of the input signal.

### BRIEF DESCRIPTION OF THE DRAWINGS

FIG. 1 is a block diagram of an embodiment of an electronic circuit according to the teachings of the present invention.

FIG. 2 is a flow chart of one embodiment of a process according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

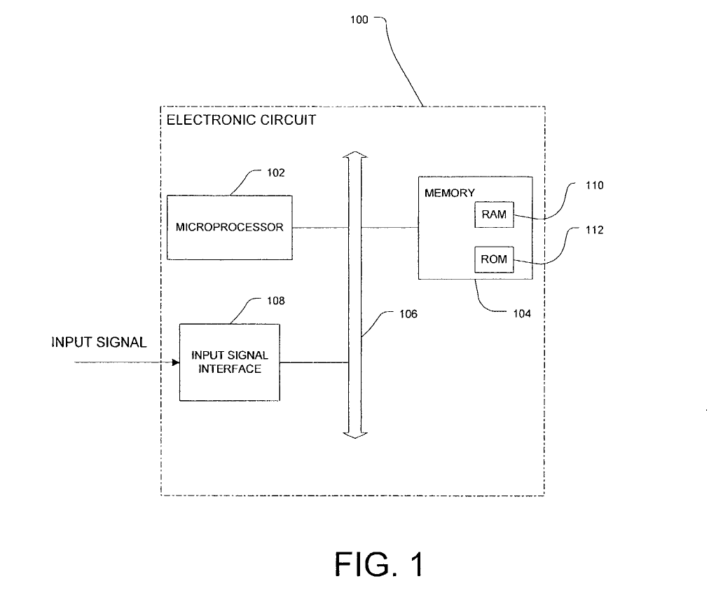

FIG. 1 is a block diagram of an embodiment of an electronic circuit, indicated generally at 100, according to the teachings of the present invention. Circuit 100 monitors an input data stream to identify specified signatures in the data stream. In one embodiment, the input signal comprises a stream of bytes or characters, referred to generally as elements, that are received from a source, e.g., over a telecommunications link, from a user input device or other appropriate signal generation mechanism.

When circuit 100 correlates the input data stream to a signature, circuit 100 takes action associated with the signature. Circuit 100, in one embodiment, takes prospective action based on partial correlation to a signature in the input data stream to allow the action to begin before the elements of the input data stream are fully correlated to the signature. In one embodiment, a subset of the elements of the signature, e.g., the first N elements of an M element signature in which M is greater than N, match the N consecutive elements of the input data stream. Advantageously, this taking of “prospective action” based on a partial correlation reduces the time lag between receiving the signature and executing the action or function by beginning the function associated with the signature during the time that the signature is being received. Once the action is commenced, it can be cancelled if the remaining portion of the input signal does not correlate to the other elements of the signature. As a further advantage, in one embodiment, electronic circuit 100 determines if a sequence of elements of the input signal correlates to all of the elements of the signature without requiring the storage of a history of the input signal as described in the '236 application. In other embodiments, prospective action is taken using more conventional correlation techniques.

Electronic circuit 100 includes microprocessor 102, memory 104 and input signal interface 108. Bus 106 provides an interface between each of microprocessor 102, memory 104 and input signal interface 108. In one embodiment, memory 104 includes random access memory (RAM) 110 and read only memory (ROM) 112. Other embodiments use any appropriate combination of memory types, including, but not limited to RAM (static or dynamic), ROM, electrically erasable programmable read only memory (EEPROM), electrically programmable read only memory (EPROM), flash memory and the like. In one embodiment, microprocessor 102 comprises a dedicated processor for performing the correlation. In other embodiments, microprocessor 102 performs additional functions for the electronic circuit. Further, in other embodiments, microprocessor 102 comprises a special purpose logic or control circuit with a limited set of functionality.

In one embodiment, electronic circuit 100 is incorporated into a computer for identifying one or more selected key combinations for initiating one or more selected actions, e.g., displaying selected data on a screen, initiating a program, etc. In other embodiments, electronic circuit 100 is incorporated in other systems such as telecommunications systems and the like to identify when expected input patterns are received so that appropriate action can be taken.

In one embodiment, electronic circuit 100 uses a number of parameters to determine correlation between the input signal and the signature. For example, electronic circuit 100 uses an index, a signature and a signature length. In one embodiment, the signature is determined at compile time and is stored in ROM 112 as an array of elements, e.g., K₀, K₁, K₂, . . . , and K_{(N-1)} for an array of N elements. In other embodiments, the signature is stored in RAM 110. Further, the length N of the signature is also determined at compile time and stored in ROM 112. In other embodiments, the length N is stored in RAM 110. Finally, the index is maintained in RAM 110 during operation of the process. This index indicates the current level of correlation between the input signal and the signature because the index is related to how many of the signature elements have been matched to sequential elements in the input stream. The index is initialized to zero during power-up initialization.

In operation, electronic circuit 100 identifies correlation between any set of sequential elements in an input signal received at input signal interface 108 with a selected signature stored in memory 104. Initially, an element of the input signal is received at interface 108. Microprocessor 102 retrieves a next element of the signature from memory 104. Until a match is found with any element of the input stream, microprocessor 102 retrieves the first element of the signature. Once the first element has been matched, microprocessor 102 retrieves successive elements of the signature so long as each element matches successive elements of the input signal. If microprocessor 102 determines that any element of the input signal does not match the compared element of the signature, then the microprocessor returns to the first element of the signature. This allows the signature to be matched without maintaining any history of the input signal in memory.

In one embodiment, microprocessor 102 takes prospective action based on a partial correlation between the input signal and the signature. For example, in one embodiment, microprocessor 102 takes action once a specified percentage of the input signal is matched such as 80 percent or other appropriate percentage. This allows circuit 100 to advantageously reduce the effective time to complete the action associated with the signature by beginning the process of implementing the action prior to complete correlation with the signature.

In one embodiment, the retrieval and comparison of elements is accomplished using the index value. Elements of the signature are retrieved based on the current value of the index. The index begins at zero. On each match between an element of the input stream and a retrieved element of the signature, the index is incremented. The next element retrieved is retrieved from a memory location determined by a base address for the signature and an offset derived from the index. When the index is equal to the length of the signature, the signature has been matched with a sequential portion of the input signal. In one embodiment, microprocessor 102 takes action once the index indicates that a selected percentage of the signature has been correlated.

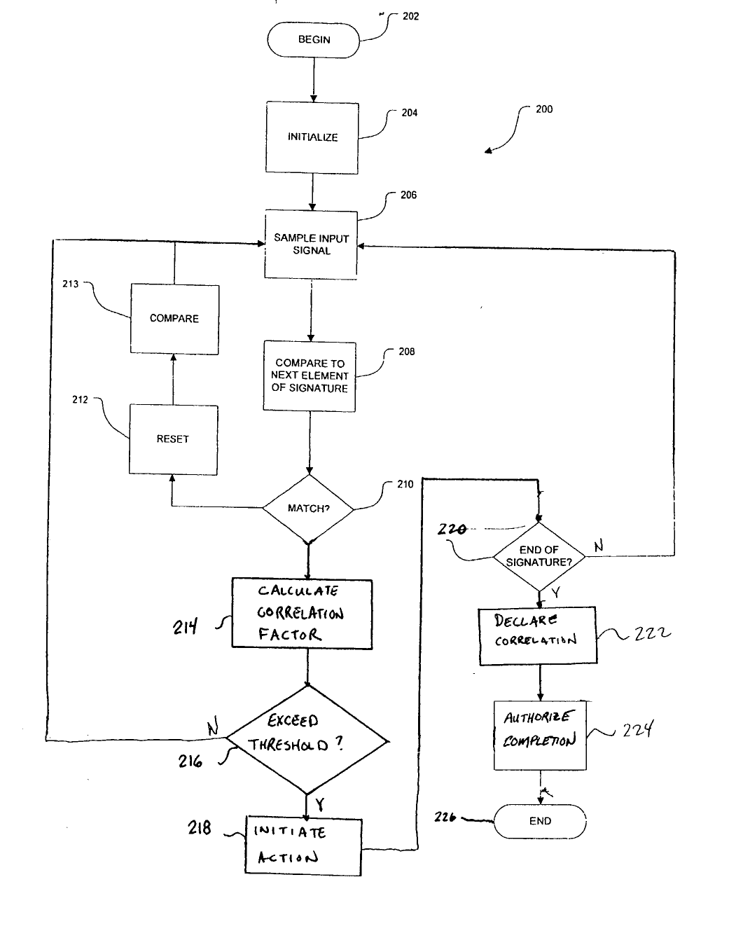

In another embodiment, electronic circuit 100 uses the process of FIG. 2, described below, to determine correlation between an input signal and a signature.

FIG. 2 is a flow chart of one embodiment of a process, indicated generally at 200, according to the teachings of the present invention. This process advantageously allows prospective action to be taken based on partial correlation between a signature and an input stream. In one embodiment, the process determines correlation between a received input signal and a signature on an element-by-element basis without maintaining a history of the received signal. As each element is received, it is compared to the next element of the signature. If there is a match, the process moves on to compare additional elements until the end of the signature is reached. If comparisons between successive elements of the input signal and the entire signature are successful, the method declares that this portion of the input signal correlates with the stored signature. When a selected portion of the signature has been correlated, the process allows the action or function associated with the signature to begin to be executed.

The process begins at block 202. At block 204, the process initializes one or more parameters used in the process. For example, in one embodiment, a signature of length N is used. In this embodiment, this signature is determined at compile time and is stored in ROM or RAM. Further, at compile time, the length of the signature is also determined and stored in ROM. In this embodiment, the process also initializes an index and stores it in memory. The index is used to selectively retrieve elements of the signature from memory during operation of the process. In other embodiments, other appropriate parameters are initialized for use in the process.

At block 206, the process receives the input signal. In one embodiment, the process receives a digital signal one element or character, e.g., one byte, at a time. Each element is processed in-turn as received and therefore it is not necessary to maintain a history of the received data. At block 208, the method compares the received element with the next element of the signature. In one embodiment, the next element of the signature is retrieved from memory based on a base address of the signature in memory and an offset based on the current value of the index. Unless the last element of the input matched its associated element of the signature, the index is zero and the received element is compared to the first element of the series. If the last element of the input signal matched an element of the signature, the index value is used to select the next element of the signature to compare to the received element.

At block 210, the method determines whether there is a match between the current element of the signature and the received element of the input signal. If not, the method proceeds to block 212 and resets to the beginning of the signature. In one embodiment, this includes resetting the index to zero. At block 212, in one embodiment, the method also stops any process initiated in block 218, described below, since the mismatch between the signature and the input stream occurred after the selected portion of the signature had been matched.

If there is no match at block 210, this means that the current string does not match the signature. The process proceeds from block 212 to block 213 and compares the current element of the input stream with the first element of the signature. The process begins again with the next received element at block 206.

At block 210, if there is a match, the process next determines if a sufficient portion of the signature has been matched to allow action to begin. At block 214, the method calculates a correlation factor to determine how much of the digital signature has been matched through the current element. For example, in one embodiment, the method calculates a correlation indicator according to the following Equation (1):

$$Correlation indicator = \frac{Index}{Signature Length} * 100 \qquad ( 1 )$$

The Correlation indicator calculated in Equation (1) essentially determines the percentage of the signature that has been identified. The Index value represents the number of elements of the signature that have been successfully identified. The Signature Length represents the total number of elements in the signature. The value returned by the operation of dividing the Index by the Signature Length provides the percentage of the signature that has been properly identified. The factor of 100 may be omitted, but, when used, places the Correlation indicator on a scale from 0 to 100. In other embodiments, the Correlation indicator is simply the quotient of the Index value and the Signature Length. In yet other embodiments, other techniques are used to provide a correlation factor. For example, a flag or other indicator is set when the Nth element of a signature is successfully compared to an element of the input stream. This flag represents a correlation factor and is only set when a match is found for the element that corresponds to a selected threshold. The action associated with the signature is allowed to proceed when the flag is set. In other embodiments, other calculations and techniques are used to indicate that a sufficient partial correlation has been achieved.

At block 216, the method determines whether the correlation factor has crossed a selected threshold. The selected threshold corresponds to a level of correlation that indicates a sufficiently high probability of successful correlation that action can be initiated. In one embodiment, this correlation level is approximately 80 percent. The exact percentage used can vary from application to application. The percentage used is selected based on factors such as the length of the signatures, the number of different signatures, the differences in the signatures, etc. Thus, in this embodiment, when the calculation at block 214 indicates a correlation factor of at least 80 percent, the method proceeds to block 218. At block 218, the method initiates action associated with the digital signature. For example, in one embodiment, the method initiates a request for data from a remote unit in a telecommunications network. In other embodiments, the method takes other appropriate actions such as calculating values for display on a computer terminal, etc. Advantageously, by using the correlation factor, the method is able to begin the action associated with a digital signature before the signature is fully correlated thereby improving the efficiency of the associated system by getting an early start on time consuming processes. In one embodiment, the method sets a flag or other indicator to indicate that the process has been initiated based on exceeding the threshold so that the action is not initiated again on subsequent passes through the method. The method proceeds to block 220.

At block 216, if the correlation factor does not exceed the threshold, then the method returns to block 206 and continues to sample the input signal and process further elements in the signature.

At block 220, the method determines whether the end of the signature has been reached. In one embodiment, reaching the end of the signature is determined by comparing the index value to the stored length of the signature. If the index value is equal to the length of the signature, then the end of the signature has been reached. If the end of the signature has not been reached, the method returns to block 206 and processes the next received element because a sequence of received elements have been received and processed that match a first portion of the signature. Returning to block 206 allows the comparison to continue until all of the elements in the signature have been matched in sequence in the input signal. If at block 220, the method determines that the current element of the input signal matched the last element of the signature, e.g., the process has reached the end of the signature, and then the process proceeds to block 222 and declares correlation. At block 224 the method authorizes completion of the tack associated with the signature so that action initiated when the correlation factor exceeded the threshold can be completed. The method ends at block 226.

In other embodiments, instructions are stored on a machine-readable medium for causing a machine to perform one or more of the processes described above. For purposes of this specification, “machine-readable medium” means a medium such as a disc, an optical disc, a dynamic or static random access memory device (DRAM, SRAM), read only memory (ROM), flash memory, electrically programmable read only memory (EPROM), electrically erasable programmable read only memory (EEPROM) or other appropriate medium for storing instructions to be read and executed by a microprocessor, a processor, an embedded processor or other appropriate logic device.

What is claimed is:

1. A method for correlating an input signal to a signature, the method comprising:
receiving an element of the input signal;
comparing the element of the input signal to an element of the signature;
when the element of the input signal matches the element of the signature, receiving and comparing a next element of the input signal to a next element of the signature;
when the element of the input signal does not match the element of the signature, comparing the element of the input signal to the first element of the signature; and
initiating action when the input signal sequentially matches at least a first portion of the elements of the signature.

2. The method of claim 1, wherein receiving an element comprises receiving a byte of data at an input signal interface.

3. The method of claim 1, and further comprising determining the next element of the signature based on an index.

4. The method of claim 3, and further comprising incrementing the index when the element of the input signal matches the element of the signature.

5. The method of claim 3, and further determining when the input signal sequentially matches the at least a first portion of the elements of the signature based on calculating a percentage of matched elements based on the index and the size of the signature.

6. A method for correlating an input signal to a signature, the method comprising:
initializing an index value;
sampling an input signal;
comparing the current sample of the input signal to an element of a signature stored at a location offset by the index value from a signature base address;
when a match is not detected, resetting the index value and returning to sampling the input signal;
when a match is detected, incrementing the index and determining whether the end of the signature is received;
determining a correlation factor on each match until a selected factor is achieved;
when the selected correlation factor is achieved, initiating an action based on the signature; and
declaring correlation when the end of the signature is reached.

7. The method of claim 6, determining a correlation factor comprises determining the percentage of elements in the signature that match consecutive samples of the input signal.

8. The method of claim 6, wherein sampling the input signal comprises receiving a byte of data from the input signal interface.

9. The method of claim 6, wherein the selected correlation factor is a selected percentage of the length of the signature.

10. A method for correlating an input signal to a signature, the method comprising:
comparing an input stream with a signature element-by-element as the input stream is received;
restarting the comparison using the first element of the signature when an element in the input stream does not match the compared element in the signature; and
on each match between an element of the input stream and the compared element of the signature, determining a correlation factor; and
initiating action when the correlation factor achieves a selected value.

11. The method of claim 10, wherein restarting the comparison comprises comparing the element in the input stream with the first element of the signature.

12. The method of claim 10, and further comprising storing the signature, a signature length and an index value in memory prior to comparing the input stream with the signature.

13. The method of claim 10, wherein comparing the input stream with the signature comprises:
receiving an element of the input stream; and
comparing the element of the input stream with an element of the signature selected based on an index.

14. The method of claim 13, and further comprising:
incrementing the index when an element of the input stream matches the selected element of the signature; and
resetting the index when an element of the input stream does not match the selected element of the signature.

15. The method of claim 13, wherein determining a correlation factor comprises calculating a percentage of the signature matched by selected elements of the input stream.

16. An electronic circuit, comprising:
a processor;
a memory for storing a signature;
an input signal interface, adapted to receive an input signal;
a bus, communicatively coupled to the processor, the memory and the input signal interface; and
wherein the processor is adapted to compare elements of the input signal with elements of the signature, and to initiate action based on the comparison when a select first portion of the signature is matched in the elements of the input signal.

17. The electronic circuit of claim 16, wherein the memory further stores an index and a size of the signature.

18. The electronic circuit of claim 16, wherein the processor initiates the action when a select percentage of the signature is matched in the input signal.

19. A machine-readable medium having instructions stored thereon for performing a method for correlating an input signal to a signature, the method comprising:
receiving an element of the input signal;
comparing the element of the input signal to an element of the signature;
when the element of the input signal matches the element of the signature, receiving and comparing a next element of the input signal to a next element of the signature;
when the element of the input signal does not match the element of the signature, comparing the element of the input signal to the first element of the signature; and
initiating action when the input signal sequentially matches at least a first portion of the elements of the signature.

20. The machine-readable medium of claim 19, wherein receiving an element comprises receiving a byte of data at an input signal interface.

21. The machine-readable medium of claim 19, and further comprising determining the next element of the signature based on an index.

22. The machine-readable medium of claim 21, and further comprising incrementing the index when the element of the input signal matches the element of the signature.

23. The machine-readable medium of claim 21, and further determining when the input signal sequentially matches the at least a first portion of the elements of the signature based on calculating a percentage of matched elements based on the index and the size of the signature.

24. A machine-readable medium having instructions stored thereon for performing a method for correlating an input signal to a signature, the method comprising:
initializing an index value;
sampling an input signal;
comparing the current sample of the input signal to an element of a signature stored at a location offset by the index value from a signature base address;
when a match is not detected, resetting the index value and returning to sampling the input signal;
when a match is detected, incrementing the index and determining whether the end of the signature is received;
determining a correlation factor on each match until a selected factor is achieved;
when the selected correlation factor is achieved, initiating an action based on the signature; and
declaring correlation when the end of the signature is reached.

25. The machine-readable medium of claim 24, determining a correlation factor comprises determining the percentage of elements in the signature that match consecutive samples of the input signal.

26. The machine-readable medium of claim 24, wherein sampling the input signal comprises receiving a byte of data from the input signal interface.

27. The machine-readable medium of claim 24, wherein the selected correlation factor is a selected percentage of the length of the signature.

28. A machine-readable medium having instructions stored thereon for performing a method for correlating an input signal to a signature, the method comprising:
comparing an input stream with a signature element-by-element as the input stream is received;
restarting the comparison using the first element of the signature when an element in the input stream does not match the compared element in the signature; and
on each match between an element of the input stream and the compared element of the signature, determining a correlation factor; and
initiating action when the correlation factor achieves a selected value.

29. The machine-readable medium of claim 28, wherein restarting the comparison comprises comparing the element in the input stream with the first element of the signature.

30. The machine-readable medium of claim 28, and further comprising storing the signature, a signature length and an index value in memory prior to comparing the input stream with the signature.

31. The machine-readable medium of claim 28, wherein comparing the input stream with the signature comprises:
receiving an element of the input stream; and
comparing the element of the input stream with an element of the signature selected based on an index.

32. The machine-readable medium of claim 31, and further comprising:
incrementing the index when an element of the input stream matches the selected element of the signature; and
resetting the index when an element of the input stream does not match the selected element of the signature.

33. The machine-readable medium of claim 31, wherein determining a correlation factor comprises calculating a percentage of the signature matched by selected elements of the input stream.

34. An electronic circuit, comprising:
a processor;
a memory for storing a signature;
an input signal interface, adapted to receive an input signal;
a bus, communicatively coupled to the processor, the memory and the input signal interface;
wherein the processor is adapted to compare elements of the input signal with elements of the signature, element-by-element as the elements are received to determine correlation between the input signal and the signature without storing the input signal;
wherein the processor is further adapted to restart with the first element of the signature when either the full signature is matched or an element of the input signal does not match a compared element of the signature; and
wherein the processor is further adapted to initiate an action or a function when a selected portion of the signature is matched in consecutive elements of the input signal.

35. A method for initiating an action based on a received signature in an input signal, the method comprising:
receiving elements of the input signal;
determining when elements of the input signal match corresponding elements in the signature; and
initiating a selected action when a selected subset of the elements of the signature match consecutive elements of the input signal.

36. The method of claim 35, and further including calculating a correlation factor to determine when to initiate the selected action.

37. The method of claim 36, wherein the correlation factor represents a percentage of the signature matched in consecutive elements of the input signal.
